(19) United States
(12) Patent Application Publication
(10) Pub. No.: US 2023/0267562 A1
(43) Pub. Date: Aug. 24, 2023

(54) METHOD AND SYSTEM FOR PROCESSING ELECTRONIC RESOURCES TO DETERMINE QUALITY

(71) Applicant: THE UNIVERSITY OF QUEENSLAND, Brisbane, Queensland (AU)

(72) Inventors: Hassan KHOSRAVI, Kuraby, Queensland (AU); Nicholas Alexander JOSEPH, Fairfield, Queensland (AU)

(21) Appl. No.: 18/024,394

(22) PCT Filed: Sep. 3, 2021
(86) PCT No.: PCT/AU2021/051025

§ 371 Date: Mar. 2, 2023

(30) Foreign Application Priority Data
Sep. 4, 2020 (AU) 2020903176

(51) Int. Cl. G06Q 50/20; G06Q 10/0639

(52) U.S. Cl. CPC G06Q 50/20; G06Q 10/06395; G09B 7/04

(57) ABSTRACT

A rating generator assembly 30 is configured to perform a method to associate quality ratings with each digital resource, such as a learning resource, of a plurality of learning resources, e.g. resources 5-1, . . . ,5-M, (Q_{M}={q₁ . . . q_{M}} in respect of a topic of an educational course. The method comprises, in respect of each of the learning resources, receiving one or more indications of quality, for example in the form of decision ratings dᵢⱼ and comments cᵢⱼ, in respect of the learning resource q₁ from respective devices (“non-expert devices” e.g. 3a, . . . ,3N) of a plurality of non-experts, for example students (U_{N}={u₁, . . . , U_{N}}) 3-1, . . . ,3-N via a data network 31. The method involves operating at least one processor, of the rating generator assembly 30 to process the one or more indications of quality from each of the respective non-expert devices 3a, . . . ,3N to determine a draft quality rating \hat{r}ᵢ and an associated level of confidence or “confidence value” of that draft quality rating. The method includes repeatedly receiving indications of quality from further of the non-expert devices and updating the draft quality rating and its associated level of confidence until the associated level of confidence meets a required confidence level. Once the required confidence level has been met the rating generator assembly sets the quality rating to the draft quality rating having the associated level of confidence meeting the required confidence level.

### RELATED APPLICATIONS

Priority is claimed from Australian patent application No. 2020903176, filed 4 Sep. 2020, the disclosure of which is hereby incorporated in its entirety by reference.

### TECHNICAL FIELD

The present disclosure relates to methods and systems for automatically determining quality ratings for digital resources, including but not limited to electronic learning resources, for example resources that are used in the delivery of educational courses to students.

### BACKGROUND ART

Any references to methods, apparatus or documents of the prior art are not to be taken as constituting any evidence or admission that they formed, or form part of the common general knowledge.

The present invention will be described primarily in relation to digital learning resources such as learning materials in respect of a topic in an educational course, however it also finds application more broadly, including the following:
1) Peer assessment where a resource being rated is a piece of assessment.
2) Peer review of academic journals where a resource being rated is a manuscript.
3) Peer review of software code where the resource being rated is programming code or script.
4) Peer review of changes made in a crowdsourcing environment such as Wikipedia where the resource being rated is the content of a webpage.

In the context of education, adaptive educational systems (AESs) [4] are information generating and processing systems that receive data about students, learning process, and learning products via electronic data networks. Prior art AESs are configured to provide an efficient, effective and customised learning experience for students by dynamically adapting learning content to suit students' individual abilities or preference. As an example, an AES may process data on the extent to which students' engagement with a resource leads to learning gains for the student population to thereby infer the quality of a learning resource.

It will be realized that given that there are often a very large number of learning resources available for any given educational course, it is highly time-consuming for instructors, e.g. lecturers and course facilitators to manually allocate a quality rating to each resource. Nevertheless, it is important that the quality of a learning resource for a particular educational course can be assessed and accurately allocated, otherwise students may spend valuable time studying a learning resource which is of low quality and which should not have been approved for use. Furthermore, it may be that the students themselves will create some of the learning resources. However, in that case, it is very time-consuming for experts such as lecturers, or other qualified instructors, to check the student authored learning resource and provide a quality rating in respect of the learning resource and constructive feedback to the student author.

In response to this problem researchers from a diverse range of fields (e.g., Learning at Scale (L@S), Artificial Intelligence in Education (AIED), Computer Supported Cooperative Work (CSCW), Human-Computer Interaction (HCI) and Educational Data Mining (EDM)) have explored the possibility of constructing processing systems that are specially configured to implement crowdsourcing approaches to support high-quality, learner-centred learning at scale. The use of processing systems that implement crowdsourcing in education, often referred to as learnersourcing, is defined as “a form of crowdsourcing in which learners collectively contribute novel content for future learners while engaging in a meaningful learning experience themselves” [16]. Recent progress in the field highlights the potential benefits of employing learnersourcing, and the rich data collected through it, towards addressing the challenges of delivering high quality learning at scale. In particular, with the increased enrolments in higher education, educational researchers and educators are beginning to use learnersourcing in novel ways to improve student learning and engagement [3,7,8,10,11,15,25-27].

However, the Inventors have found that processing systems that are configured to implement traditional reliability-based inference methods that have been demonstrated to work effectively in the context of other crowdsourcing systems may not work well in education.

It would be desirable if a solution could be provided that is at least capable of receiving one or more indications of quality in respect of learning resources from respective devices of a plurality of non-experts via a data network and processing those indications of quality to set quality ratings in respect of the learning resources.

### SUMMARY

According to a first aspect there is provided a method to associate quality ratings with each digital resource of a plurality of digital resources, the method comprising, in respect of each of the digital resources:
(a) receiving one or more indications of quality of the digital resource from respective devices (“non-expert devices”) of a plurality of non-experts via a data network;
(b) operating at least one processor to process the one or more indications of quality from each of said respective non-expert devices to determine a draft quality rating and a level of confidence therefor;
(c) repeating (a) in respect of indications of quality from further of the non-expert devices and (b) to update the draft quality rating until the level of confidence meets a required confidence level; and
(d) setting the quality rating to the draft quality rating having an associated level of confidence meeting the required confidence level.

In an embodiment the method includes operating the at least one processor to classify the digital resource as an approved resource based upon the quality rating.

In an embodiment the method includes operating the at least one processor to classify the digital resource as an approved resource or as a rejected resource based upon the quality rating.

In an embodiment the method includes operating the at least one processor to transmit a message to a device of an author of the rejected resource, the message including the quality rating and one or more of the one or more indications of quality received at (a).

In an embodiment the one or more indications of quality include decision ratings (dᵢⱼ) provided by the non-experts (uᵢ) in respect of the digital resource (qᵢ)

In an embodiment the one or more indications of quality include comments (cᵢⱼ) provided by the non-experts (uᵢ) in respect of the digital resource (qᵢ).

In an embodiment the method includes operating the at least one processor to process the comments in respect of the digital resource to quantify the comments as indicating a degree of positive or negative sentiment toward the digital resource.

In an embodiment operating the at least one processor to process the comments to quantify the comments as indicating a degree of positive or negative sentiment toward the digital resource includes operating the at least one processor to apply a sentiment lexicon to the comments to compute sentiment scores.

In an embodiment the method includes operating the at least one processor to calculate a reliability indicator in respect of each non-expert indicating reliability of the indications of quality provided by the non-expert.

In an embodiment in (b),

operating at least one processor to process the one or more indications of quality from each of said respective non-expert devices to determine the draft quality rating and the level of confidence therefor includes:
affording a greater weight to indications of quality from non-experts with a higher reliability indicator and a lower weight to indications of quality from non-experts with a lower reliability indicator when determining the draft quality rating and the level of confidence therefor.

In an embodiment the method includes operating the at least one processor to transmit the reliability indicators across the data network to respective non-expert devices of the non-experts for viewing by the non-experts.

In an embodiment the method includes calculating a reliability indicator for each non-expert comprises:
setting reliability indicators of all students to an initial value;
computing a quality rating for a resource based on current values of the reliability indicators of a number of the non-experts;
updating the reliability indicators according to a heuristic procedure.

In an embodiment the heuristic procedure comprises:
calculating:

$${\hat{r}}_{J} = \frac{{Σ}_{i = 1}^{k} {w}_{i} \times {d}_{ij}}{{Σ}_{i = 1}^{k} {w}_{i}} , {w}_{i} := {w}_{i} + {f}_{ij}^{R} \qquad ( 1 )$$

where fᵢⱼ^{R} computed as a height of a Gaussian function at value difᵢⱼ with centre 0 using

$${f}_{ij}^{R} = δ \times \frac{{e}^{- {( {d}_{i} {f}_{ij} )}^{2} / ( 2 {σ}^{2} )}}{σ \sqrt{2 π}} - \frac{δ}{2}$$

where hyper-parameters σ and δ are learned via cross-validation.

In an embodiment the heuristic procedure comprises:
calculating:

$${\hat{r}}_{J} = \frac{{Σ}_{i = 1}^{k} ( {w}_{i} \times {f}_{ij}^{L} ) \times {d}_{ij}}{{Σ}_{i = 1}^{k} ( {w}_{i} + {f}_{ij}^{L} )} , {w}_{i} := {w}_{i} + {f}_{ij}^{L} \qquad ( 2 )$$

where F_{N×M}^{L} is a function in which fᵢⱼ^{L} is computed based on a logistic function

$$\frac{c}{1 + a {e}^{- k \times l {c}_{ij}}}$$

where the hyper-parameters c, a and k of the logistic function are learned via cross-validation.

In an embodiment the heuristic procedure comprises:
calculating:

$${\hat{r}}_{J} = \frac{{Σ}_{i = 1}^{k} ( {w}_{i} \times {f}_{ij}^{A} ) \times {d}_{ij}}{{Σ}_{i = 1}^{k} ( {w}_{i} + {f}_{ij}^{A} )} , {w}_{i} := {w}_{i} + {f}_{ij}^{A} \qquad ( 3 )$$

where fᵢⱼ^{A} approximates alignment of rating dᵢⱼ and comment cᵢⱼ a user uᵢ has provided for a resources qⱼ.

In an embodiment the heuristic procedure includes determining the reliability indicators using a combination of two or more of each of the following three heuristic procedures:
calculating:

$${\hat{r}}_{J} = \frac{{Σ}_{i = 1}^{k} {w}_{i} \times {d}_{ij}}{{Σ}_{i = 1}^{k} {w}_{i}} , {w}_{i} := {w}_{i} + {f}_{ij}^{R} \qquad ( 1 )$$

where fᵢⱼ^{R} is computed as a height of a Gaussian function at value difᵢⱼ with centre 0 using

$${f}_{ij}^{R} = δ \times \frac{{e}^{- {( {d}_{i} {f}_{ij} )}^{2} / ( 2 {σ}^{2} )}}{σ \sqrt{2 π}} - \frac{δ}{2}$$

where hyper-parameters σ and δ are learned via cross-validation; and/or
calculating:

$${\hat{r}}_{J} = \frac{{Σ}_{i = 1}^{k} ( {w}_{i} \times {f}_{ij}^{L} ) \times {d}_{ij}}{{Σ}_{i = 1}^{k} ( {w}_{i} + {f}_{ij}^{L} )} , {w}_{i} := {w}_{i} + {f}_{ij}^{L} \qquad ( 2 )$$

where F_{N×M}^{L} is a function in which fᵢⱼ^{L} is computed based on a logistic function

$$\frac{c}{1 + a {e}^{- k \times l {c}_{ij}}}$$

where the hyper-parameters c, a and k of the logistic function are learned via cross-validation; and/or
calculating:

$${\hat{r}}_{J} = \frac{{Σ}_{i = 1}^{k} ( {w}_{i} \times {f}_{ij}^{A} ) \times {d}_{ij}}{{Σ}_{i = 1}^{k} ( {w}_{i} + {f}_{ij}^{A} )} , {w}_{i} := {w}_{i} + {f}_{ij}^{A} \qquad ( 3 )$$

where fᵢⱼ^{A} approximates alignment of the rating dᵢⱼ and the comment cᵢⱼ a user uᵢ has provided for a resources qⱼ.

In an embodiment the method includes establishing data communications with respective devices (“expert devices”) of a number of experts via the data network.

In an embodiment the method includes requesting an expert of the number of experts to review a digital resource.

In an embodiment the method includes receiving a quality rating (“expert quality rating”) from the expert via an expert device of the expert in respect of the digital resource.

In an embodiment the method includes operating the at least one processor to set a quality rating in respect of the digital resource to the expert quality rating.

In an embodiment the method includes transmitting feedback on the digital resource received from the expert across the data network, to an author of the digital resource.

In an embodiment the method includes transmitting a request to the expert device for the expert to check indications of quality received from the non-expert devices for respective digital resources.

In an embodiment the method includes operating the at least one processor to adjust reliability ratings of non-experts based on the check by the expert of the indications of quality received from the non-expert devices.

In an embodiment the non-experts comprise students.

In an embodiment experts comprise instructors in an educational course.

In an embodiment the method includes providing the digital resources comprising learning resources to the students.

The digital resource may comprise a piece of assessment in the educational course.

The digital resource may comprise a manuscript for submission to a journal The non-experts may comprise academic reviewers The experts may comprise meta reviewers or editors of the journal.

The digital resource may comprise software code such as source code or a script. The non-expert may comprise a junior engineer. The expert may comprise a senior engineer or team leader.

The digital resource may comprise an electronic document, for example a web page, made in a crowdsourcing environment such as Wikipedia. The non-expert may comprise a regular user. The expert may comprise moderators of groups of the crowdsourcing environment.

In an embodiment the method includes operating the at least one processor to process the digital resources to remove authorship data therefrom prior to providing them to the non-expert.

In another aspect there is provided a system for associating quality ratings with each digital resource of a plurality of digital resources, the system comprising:
a plurality of non-expert devices of respective non-experts;
a rating generator assembly;
a data network placing the plurality of non-expert devices in data communication with the rating generator assembly;
one or more data sources accessible to or integrated with the rating generator assembly for storing the digital resources;
   wherein the rating generator assembly is configured to:
(a) receive one or more indications of quality from the non-expert devices via the data network;
(b) process the one or more indications of quality from each of said respective non-expert devices to determine a draft quality rating and level of confidence therefor;
(c) repeat step (a) for indications of quality from further of the non-expert devices and step (b) to thereby update the draft quality rating until the level of confidence meets a required confidence level; and
(d) set the quality rating to the draft quality rating having an associated level of confidence meeting the required confidence level.

In an embodiment the rating generator of the system is further configured to perform one or more of each of the embodiments of the previously mentioned method.

In a further aspect there is provided a rating generator assembly for associating quality ratings with each digital resource of a plurality of digital resources, the rating generator assembly comprising:
a communications port for establishing data communications with a plurality of respective devices (“non-expert devices”) of a plurality of non-experts via a data network;
at least one processor responsive to the communications port;
at least one data source storing the plurality of digital resources and in data communication with the at least one processor;
an electronic memory bearing machine readable instructions for execution by the at least one processor, the machine-readable instructions including instructions for the at least one processor to perform, for each of the digital resources;
(a) receiving one or more indications of quality of the digital resource from the non-expert devices via a data network;
(b) processing the one or more indications of quality from each of said respective non-expert devices to determine a draft quality rating and level of confidence therefor;
(c) repeating (a) for indications of quality from further of the non-expert devices and (b) to update the draft quality rating until the level of confidence meets a required confidence level; and
(d) setting the quality rating to the draft quality rating having an associated level of confidence meeting the required confidence level.

In an embodiment the rating generator is further configured to perform one or more of each of the embodiments of the previously mentioned method.

According to another aspect of the present invention there is provided a method to associate quality ratings with each digital resource of a plurality of digital resources the method comprising receiving one or more indications of quality of the digital resource from respective devices (“non-expert devices”) of a plurality of non-experts via a data network and setting the quality rating taking into account the received indications of quality.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary in any way. The Detailed Description mentions features that are preferable but which the skilled addressee will realize are not essential to all aspects and/or embodiments of the invention. The Detailed Description will refer to a number of drawings as follows:

FIG. 1 depicts a system for allocating quality ratings to digital resources comprising learning resources, including a rating generator assembly according to an embodiment of the invention.

FIG. 2 is a block diagram of the rating generator assembly.

FIG. 3A is a first portion of a flow chart of a method according to an embodiment that is implemented by the rating generator assembly.

FIG. 3B is a second portion of the flowchart of the method according to an embodiment that is implemented by the rating generator assembly.

FIGS. 4 to 6 depict screens comprising webpages rendered on devices in communication with the rating generator assembly during performance of the method.

FIG. 7 depicts a device of an administrator displaying a webpage served by the rating generator assembly indicating feedback in respect of a particular learning resource.

FIG. 8 depicts a screen comprising a webpage rendered on a device of a student recommending learning resources that are indicated as best suiting the students learning needs, during performance of the method.

FIG. 9 depicts a webpage rendered on an administrator's screen that graphically illustrates high priority activities for an instructor.

FIG. 10 depicts a webpage that is rendered to an administrator, and which identifies problematic users and the associated reason for them having been flagged as such.

FIG. 11 depicts a screen presenting quality rating and reliability ratings on an administrator device.

FIG. 12 depicts a screen presenting information in relation to the performance of students on an instructor's device

### DETAILED DESCRIPTION OF PREFERRED EMBODIMENTS

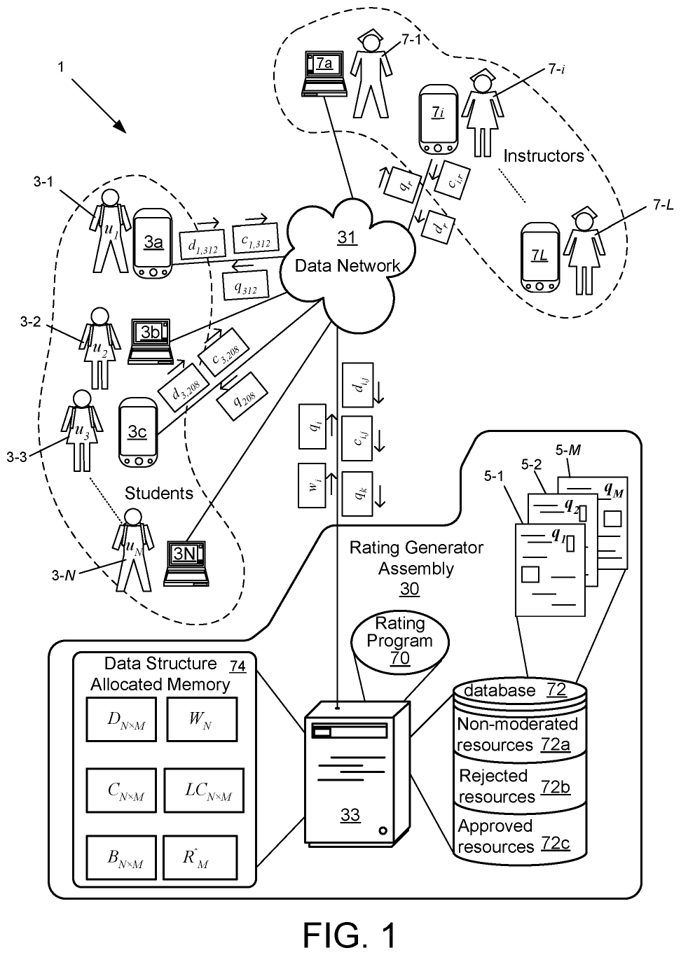

FIG. 1 is a block diagram of a rating system 1 for automatically allocating quality ratings to each of a number of electronic digital resources, for example in the form of learning resources Q_{M}={q₁, . . . ,q_{M}} identified as items 5-1, . . . ,5-M in FIG. 1. The electronic learning resources may be in the form of video, text, multi-media, webpage or any other suitable format that can be stored in an electronic file storage assembly. The method can also be used for allocating quality ratings to other types of digital resources, non-exhaustively including: a piece of assessment such as an essay or report, an academic manuscript, computer program code or strip and webpage content.

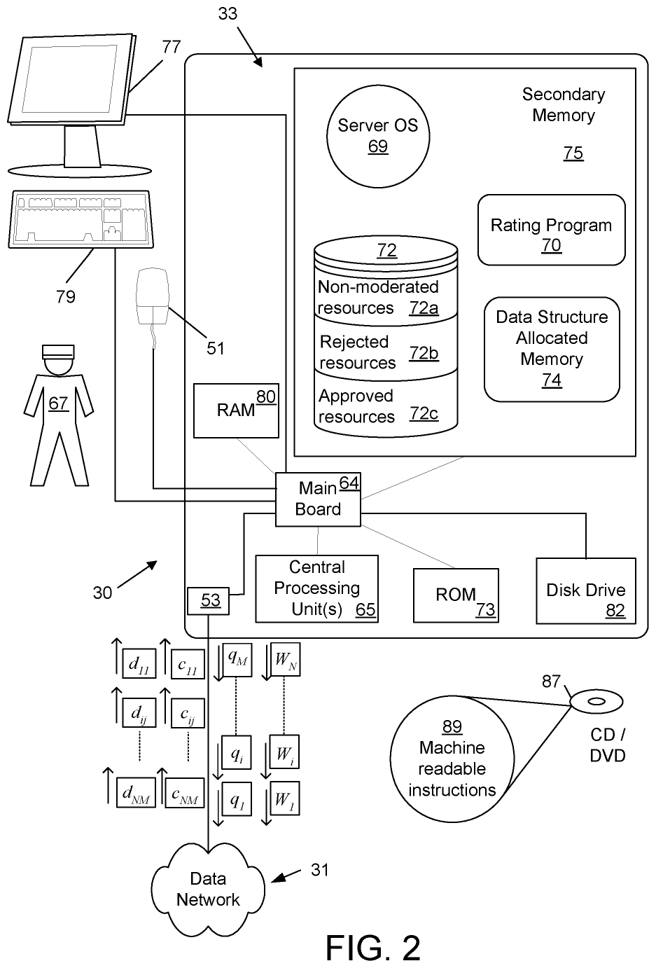

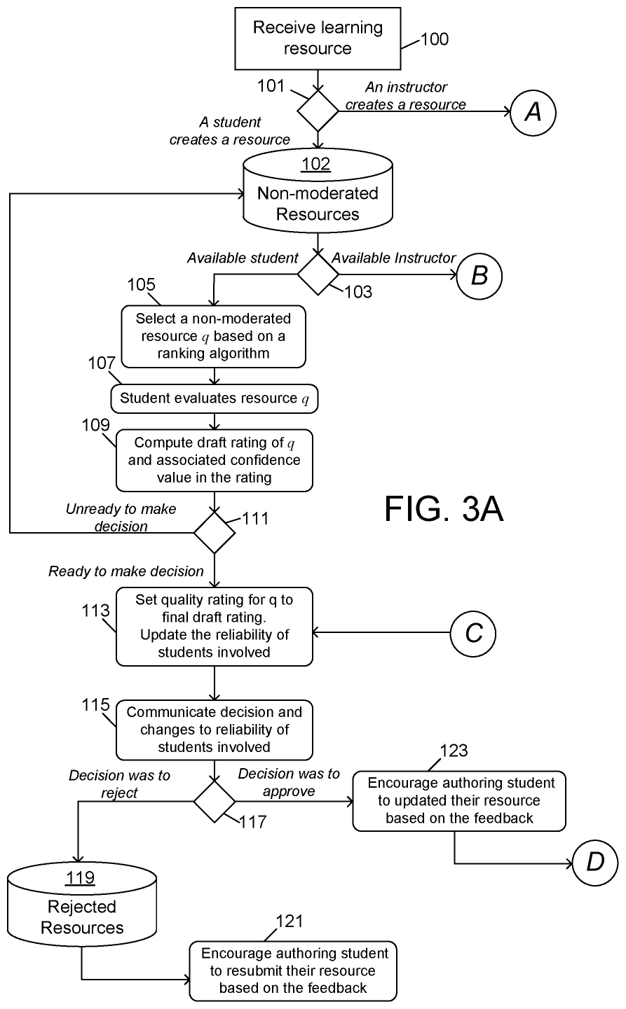

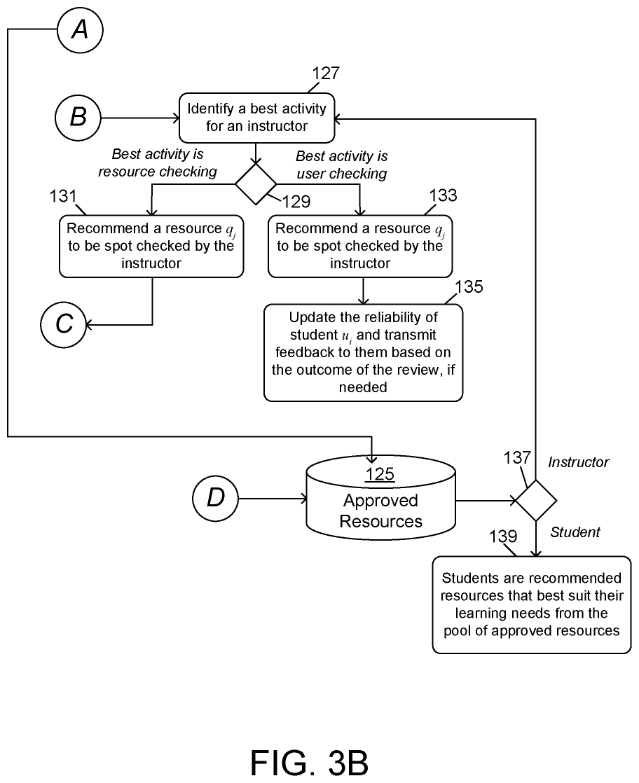

The rating system 1 comprises a rating generator assembly 30 which is comprised of a server 33 (shown in detail in FIG. 2) in combination with, and specially configured by, a rating program 70. The rating program 70 is comprised of instructions for execution by one or more processors of the server 33 in order for the rating generator assembly 30 to implement a learning resource rating method. The learning resource rating method, according to a preferred embodiment, will be subsequently described with reference to the flowchart of FIG. 3A and FIG. 3B and the block diagram of FIG. 1. In the presently described embodiment the electronic learning resources are stored in a data source in the form of a database 72 that is implemented by rating generator assembly 30 as configured by the rating program 70, in accordance with a method that will be described with reference to the flowchart of FIG. 3A and FIG. 3B.

Database 72 is arranged to store learning resources 5-1, . . . ,5-M (Q_{M}={qᵢ, . . . ,q_{M}}) so that they can each be classed as non-moderated resources 72a, rejected resources 72b or approved resources 72c. Whilst database 72 is illustrated as a single database partitioned into areas 72a, 72b and 72c, it will be realized that many other functionally equivalent arrangements are possible. For example the database areas 72a, 72b, 72c could be implemented as respective discrete databases in respective separate data storage assemblies which may not be implemented within storage of rating generator assembly but instead may be situated remotely and accessed by rating generator assembly 30 across data network 31.

The data network 31 of rating system 1 may be the Internet or alternatively, it could be an internal data network, e.g. an intra-net in a large organization such as a University. The data network 31 places non-expert raters in the form of students (U_{N}={u₁, . . . ,u_{N}}) 3-1, . . . ,3-N, via their respective devices 3a, . . . ,3N (“non-expert devices”) in data communication with the rating generator assembly 30. Similarly, the data network 31 also places experts in the form of Instructors 7-1, . . . ,7-L, via their respective devices 7a, . . . ,7L (“expert devices”) in data communication with the rating generator assembly 30.

As will be explained, during its operation the rating generator assembly performs a method to associate quality ratings with each digital resource. In the present example the digital resource is a learning resource of a plurality of learning resources in respect of a topic of an educational course.

Before describing the method further, an example of server 33 will be described with reference to FIG. 2. Server 33 includes a main board 64 which includes circuitry for powering and interfacing at least one processor in the form of one or more onboard microprocessors or “CPUs” 65.

The main board 64 acts as an interface between CPUs 65 and secondary memory 75. The secondary memory 75 may comprise one or more optical or magnetic, or solid state, drives. The secondary memory 75 stores instructions for an operating system 69. The main board 64 also communicates with random access memory (RAM) 80 and read only memory (ROM) 73. The ROM 73 typically stores instructions for a startup routine, such as a Basic Input Output System (BIOS) or Unified Extensible Firmware Interface (UEFI) which the CPUs 65 access upon start up and which preps the CPUs 65 for loading of the operating system 69.

The main board 64 also includes an integrated graphics adapter for driving display 77. The main board 64 accesses a communications port, for example communications adapter 53, such as a LAN adaptor (network interface card) or a modem that places the server 33 in data communication with data network 31.

An operator 67 of server 33 interfaces with server 33 using keyboard 79, mouse 51 and display 77 or alternatively, and more usually, via a remote terminal across data network 31.

Subsequent to the BIOS or UEFI, and thence the operating system 69, booting up the server the operator 67 may operate the operating system 69 to load the rating program 70 to configure server 33 to thereby provide the rating generator assembly 30. The rating program 70 may be provided as tangible, non-transitory, machine-readable instructions 89 borne upon a computer- readable media such as optical disk 87 for reading by disk drive 82. Alternatively, rating program 70 might also be downloaded via port 53 from a remote data source such as a cloud-based data storage repository.

The secondary memory 75, is an electronic memory typically implemented by a magnetic or non-volatile solid-state data drive and stores the operating system 69. For example, Microsoft Windows Server, and Linux Ubuntu Server are two examples of such an operating system.

The secondary memory 75 also includes the rating program 70, being a server-side program according to a preferred embodiment of the present invention. The rating program 70 is comprised of machine-readable instructions for execution by the one or more CPUs 65. The secondary storage bears the machine-readable instructions. Rating program 70 may be programmed using one or more programming languages such as PHP, JavaScript, Java, and Python. The rating program 70 implements a data source in the form of the database 72 that is also stored in the secondary memory 75, or at another location accessible to the server 33, for example via the data network 31. The database 72 stores learning resources 5-1, . . . ,5-M so that they are identifiable as non-moderated resources 72a, rejected resources 72b and approved resources 72c. As previously alluded to, in other embodiments separate databases may be used to respectively store one or more of the non-moderated, rejected and approved resources.

During an initial phase of operation of the server 33 the one or more CPUs 65 load the operating system 69 and then load the rating program 70 to thereby provide, by means of the server 33 in combination with the rating program 70, the rating generator assembly 30.

In use, the server 33 is operated by the administrator 67 who is able to monitor activity logs and perform various housekeeping functions from time to time in order to keep the server 33 operating optimally.

It will be realized that server 33 is simply one example of an environment for executing rating program 70. Other suitable environments are also possible, for example the rating generator assembly 30 may be implemented by a virtual machine in a cloud computing environment in combination with the rating program 70. Dedicated machines which do not comprise specially programmed general-purpose hardware platforms, but which instead include a plurality of dedicated circuit modules to implement the various functionalities of the method are also possible.

Methods that are implemented by the rating generator assembly 30 to process the student decision ratings and comments in respect of the learning resources will be described in the following sections of this specification. These methods are coded as machine readable-instructions which comprise the rating program 70 and which are implemented by the CPUs 65 of the server 33.

Table 1 provides a summary of the notation used to describe various procedures of a method according to an embodiment of the invention that is coded into the rating program 70 of the rating generator assembly 30 in the presently described example.

TABLE 1
Notation used herein.
Input Parameters

| | |
|---|---|
| U_{N} | A set of non-experts, e.g. students {u₁ . . . u_{N}} who |
| | are enrolled in the course. |
| Q_{M} | A repository of digital resources such as learning |
| | resources {q₁ . . . q_{M}} available within the system. |
| D_{N×M} | A two-dimensional array in which 1 ≤ dᵢⱼ ≤ 5 shows the |
| | decision rating given by user uᵢ to resource qⱼ. |
| C_{N×M} | A two-dimensional array in which cᵢⱼ denote the comment |
| | provided by user uᵢ on resource qⱼ. |

Aggregation-based Models

| | |
|---|---|
| B_{N} | A set of users' bias {b₁ . . . b_{N}} in which bᵢ shows the |
| | bias of student uᵢ in rating the quality of resources. |
| d̅ᵢ | The average decision rating of user uᵢ. |
| d̅ | The average decision rating across all users. |

Reliability-based Models

| | |
|---|---|
| W_{N} | A set of users' reliability {w₁ . . . w_{N}} in which wᵢ |
| | infers the reliability of a user uᵢ. |
| α | The initial value of the reliability of all students. |
| LC_{N×M} | A two-dimensional array in which lcᵢⱼ denote the length |
| | of the comment provided by user uᵢ on resource qⱼ. |
| F_{N×M}^{R} | A function where fᵢⱼ^{R} determines the quality of the rating |
| | provided by uᵢ for qⱼ. |
| F_{N×M}^{L} | A function where fᵢⱼ^{L} approximates the ’effort’ of uᵢ in |
| | evaluating qⱼ. |
| F_{N×M}^{A} | A function where fᵢⱼ^{A} approximates the alignment between |
| | the rating and comment provided by uᵢ on qⱼ. |

Output

| | |
|---|---|
| R\hat{ }_{M} | A set of M ratings {r\hat{ }₁ . . . r\hat{ }_{M}} where each rating 1 ≤ r\hat{ }ⱼ ≤ 5 |
| | shows the quality of resource qⱼ. |

With reference to FIG. 1, rating program 70 comprises instructions configuring server 33 of rating generator assembly 30 to allocate memory to represent variables U_{N}={u₁ . . . u_{N}} denoting a set of non-expert moderators being the set of students, e.g. students 3-1, . . . ,3-N, who are enrolled in a course in an educational system, where uᵢ refers to an arbitrary student. Q_{M}={q₁ . . . q_{M}} comprises a content model, denoting a repository, e.g. database 72, of digital resources, e.g. resources 5-1, . . . ,5-M, (Q_{M}={q₁ . . . q_{M}) that are available to the students where qⱼ refers to an arbitrary learning resource. Two-dimensional array D_{N×M} denote decision ratings where 1≤dᵢⱼ≤5 shows the decision rating given by user uᵢ to resource qⱼ. Two-dimensional array C_{N×M} denote comments that are provided to accompany decision ratings where cᵢⱼ denote the comment provided by user uᵢ with respect to resource qⱼ. Using the information available in D_{N×M} and C_{N×M}, a preferred embodiment of the method implemented by rating generator assembly 30 determines \hat{R}_{M}=\hat{r}₁ . . . \hat{r}_{M}}, where 1≤\hat{r}ⱼ≤5 indicates the quality of learning resource qⱼ. Corresponding variables and data structures, e.g. one and two-dimensional arrays, for the sets and variable described in Table 1 are created in allocated memory 74 of server 33 in accordance with instructions of the rating program 70.

In a first embodiment the rating generator assembly 30 is configured to perform a method to associate quality ratings with each digital resource, wherein the digital resource may be a learning resource of a plurality of learning resources, e.g. resources 5-1, . . . ,5-M, (Q_{M}={q₁ . . . q_{M}}) in respect of a topic of an educational course. The method comprises, in respect of each ofthe learning resources, receiving one or more indications of quality, for example in the form of decision ratings dᵢⱼ and comments cᵢⱼ, in respect of the learning resource q₁ from respective devices (“non-expert devices” e.g. 3a, . . . ,3N) of a plurality of non-experts, for example students (U_{N}={u₁, . . . ,u_{N}}) 3-1, . . . ,3-N via a data network 31. The method involves operating at least one processor, e.g. CPU(s) 65 of rating generator assembly 30 to process the one or more indications of quality from each of the respective non-expert devices 3a, . . . ,3N to determine a draft quality rating \hat{r}ᵢ and an associated level of confidence or “confidence value” of that draft quality rating. The method includes repeatedly receiving indications of quality from further of the non-expert devices and updating the draft quality rating and its associated level of confidence until the associated level of confidence meets a required confidence level. Once the required confidence level has been met the rating generator assembly sets the quality rating to the draft quality rating having the associated level of confidence meeting the required confidence level. The method of this first embodiment is reflected in boxes 102 to 113 of the flowchart of the preferred embodiment that is set out in FIG. 3A and FIG. 3B.

In the preferred embodiment of the invention that will be described with reference to the flowchart of FIG. 3A and 3B, additional procedures are also enacted by the rating generator assembly 30 such as engaging with the Instructors 7-1, . . . ,7-L and using decision ratings and comments received from the Instructors to update reliability ratings for the students and to spot-check the quality ratings of the learning resources. The additional features are preferable and useful but are not essential to the first embodiment.

Prior to discussing the preferred embodiment with reference to the entire flowchart of FIG. 3A and FIG. 3B, it will be explained that a widely used method for inferring an outcome from a set of individual decisions is to use statistical aggregations such as mean or median. A third method that will be discussed uses aggregation functions to identify and address user bias. In the explanation of the models given below, decision ratings and associated comments from a set of users {u₁ . . . uₖ} on a resource qⱼ are used to infer \hat{r}ⱼ.

Mean. A simple solution is to use mean aggregation, where

$${\hat{r}}_{J} = \frac{{Σ}_{i = 1}^{k} {d}_{ij}}{k} , .$$

There are two main drawbacks to using mean aggregation: (1) it is strongly affected by outliers and (2) it assumes that the contribution of each student has the same quality, whereas in reality, students' academic ability and reliability may vary quite significantly across a cohort.

Median. An alternative simple solution is to use \hat{r}ⱼ=Median(u₁, . . . uₖ). A benefit of using median is that it is not strongly affected by outliers; however, similar to mean aggregate, it assumes that the contribution of each student has the same quality, which is a strong and inaccurate assumption.

User Bias. Some students may consistently underestimate (or overestimate) the quality of resources and it is desirable to address that. We introduce the notation of B_{N}, where bᵢ shows the bias of user uᵢ in rating. Introducing a bias parameter has been demonstrated to be an effective way of handling user bias in different domains such as recommender systems and crowd consensus approaches [17]. We first compute d̅ᵢ as the average decision rating of a user uᵢ. We then compute

$$\overline{d} = \frac{{Σ}_{i = 1}^{N} {\overline{d}}_{i}}{N}$$

as the average decision rating across all users. The bias term for user uᵢ is computed as bᵢ=d̅ᵢ−d̅. A positive bᵢ shows that uᵢ provides higher decision ratings compared to the rest of the cohort and similarly a negative bᵢ shows that uᵢ provides lower decision ratings compared to the rest of the cohort. To adjust for bias, the quality or “rating” of resource qⱼ can be inferred as.

$${r}_{J} = \frac{{\sum }_{i = 1}^{k} ( {d}_{ij} - {b}_{i} )}{k} .$$

Students within a cohort can have a large range of academic abilities. The one-dimensional array W_{N}, is used where wᵢ infers the reliability of a user so that more reliable students can have a larger contribution (i.e. “weight”) towards the computation of the final decision. Many methods have been introduced in the literature for computing reliability of users [30]. The problems of inferring the reliability of users W_{M} and quality of resources R_{M} can be seen as solving a “chicken-and-egg” problem where inferring one set of parameters depends on the other. If the true reliability of students W_{M} were known, then an optimal weighting of their decisions could be used to estimate R_{M}. Similarly, if the true quality of resources R_{M} were known, then the reliability of each student W_{N} could be estimated. In the absence of ground truth for either, the Inventors have conceived of three heuristic methods (which make use of equations (1) to (3) in the following), that may be employed in some embodiments whereby students can view updates to their reliability score. In each of the heuristic methods:
(i) set the reliability of all students to an initial value of α;
(ii) compute \hat{r}ⱼ for a resource qⱼ based on current values of w₁, . . . wₖ and d₁, . . . dₖ and c₁, . . . cₖ;
(iii) update w₁, . . . wₖ.

The methods of computing \hat{r}ⱼ and updating w₁, . . . wₖ in each of the three methods will now be discussed.

Rating. In this method, the current ratings of the users and their given decisions are utilised for computing the quality of the resources and reliabilities. In this method, \hat{r}ⱼ and wᵢ are computed using Formula 1 as follows:

$${\hat{r}}_{J} = \frac{{Σ}_{i = 1}^{k} {w}_{i} \times {d}_{ij}}{{Σ}_{i = 1}^{k} {w}_{i}} , {w}_{i} := {w}_{i} + {f}_{ij}^{R} \qquad ( 1 )$$

where F_{N×M}^{R} is a function in which fᵢⱼ^{R} determines the ‘goodness’ of dᵢⱼ based on \hat{r}ⱼ using the distance between the two difᵢⱼ=|dᵢⱼ−\hat{r}ⱼ|. Formally, fᵢⱼ^{R} is computed as the height of a Gaussian function at value difᵢⱼ with centre 0 using

$${f}_{ij}^{R} = δ \times \frac{{e}^{- {( {d}_{i} {f}_{ij} )}^{2} / ( 2 {σ}^{2} )}}{σ \sqrt{2 π}} - \frac{δ}{2}$$

where the hyper-parameters σ and δ can be learned via cross-validation. Informally, fᵢⱼ^{R} provides a large positive value (reward) in cases where difᵢⱼ is small and it provides a large negative value (punishment) in cases where difᵢⱼ is large.

Length of Comment. The reliability of a user decision in the previous scenario relies on the numeric ratings provided for a resource and it does not take into account how much effort was applied by a user in the evaluation of a resource. In this method, the current ratings, as well as decisions and comments of users, are utilised for computing the quality of the resources and updating reliabilities. The notation of LC_{N×M}, is used where lcᵢⱼ shows the length of comments (i.e., number of words) provided by user uᵢ on resource qⱼ. \hat{r}ⱼ and wᵢ are computed using Formula 2 as follows:

$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{L} \qquad ( 2 )$$

where F_{N×M}^{L} is a function in which fᵢⱼ^{L} approximates the ‘effort’ of uᵢ in answering qⱼ based on the length of comment lcᵢⱼ. Formally, fᵢⱼ^{L} is computed based on the logistic function

$$\frac{c}{1 + {ae}^{- k \times {lc}_{ij}}}$$

where the hyper-parameters c, a and k of the logistic function can be learned via cross-validation. Informally, fᵢⱼ^{L} rewards students that have provided a longer explanation for their rating and punishes students that have provided a shorter explanation for their rating.

Rating-Comment Alignment. The previous two reliability-based models take into account the similarity of the students' numeric rating with their peers and the amount of effort they have spent on moderation by the length of their comments. Here, the alignment between the ratings and comments provided by a user are considered. In this method, \hat{r}ⱼ and wᵢ are computed using Formula 3 as follows:

$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{A} \qquad ( 3 )$$

Where F_{N×M}^{A} is a function where fᵢⱼ^{A} approximates the alignment of the rating dᵢⱼ and the comment cᵢⱼ a user uᵢ has provided for a resources qⱼ. A sentiment analysis tool that assesses the linguistic features in the comments provided by the students on each resource, is used to classify the words in terms of emotions into positive, negative and neutral. The Jockers-Rinker sentiment lexicon provided in the SentimentR package is applied here to compute a sentiment score between −1 to 1 with 0.1 interval which indicates a degree of sentiment present in the comments. This package assigns polarity to words in strings with valence shifters [21,18]. For example, it would recognize this sample comment “This question is Not useful for this course” as negative rather than indicating the word “useful” as positive.

Combining Reliability functions. Any combination of the presented three reliability functions can also be considered. For example, Formula 4 uses all three of the rating, length of comment and rating comment alignment methods for reliability.

$${\hat{r}}_{j} = \frac{{\sum }_{i = 1}^{k} ( {w}_{i} + {F}_{ij}^{L} + {f}_{ij}^{A} ) \times {d}_{ij}}{{\sum }_{i = 1}^{k} ( {w}_{i} + {F}_{ij}^{L} + {F}_{ij}^{A} )} , {w}_{i} := {w}_{i} + {F}_{ij}^{R} + {F}_{ij}^{L} + {F}_{ij}^{A} \qquad ( 4 )$$

Referring now to FIG. 3A and FIG. 3B, there is presented flowchart of a method according to a preferred embodiment of the invention that corresponds to instructions coded into rating program 70 and which is implemented by rating generator assembly 30 comprised of server 33 in combination with the rating program 70.

Prior to performing the method the rating generator assembly 30 establishes data communication with each of the students 3-1, . . . ,3-N and Instructors, 7-1, . . . ,7L via data network 31 for example by serving webpages composed of e.g. HTML, CSS and JavaScript to their devices 3a, . . . ,3N and 7a, . . . ,7L with http or https protocols for rendering on suitable web-browsers running on each of the devices (as depicted in FIG. 1).

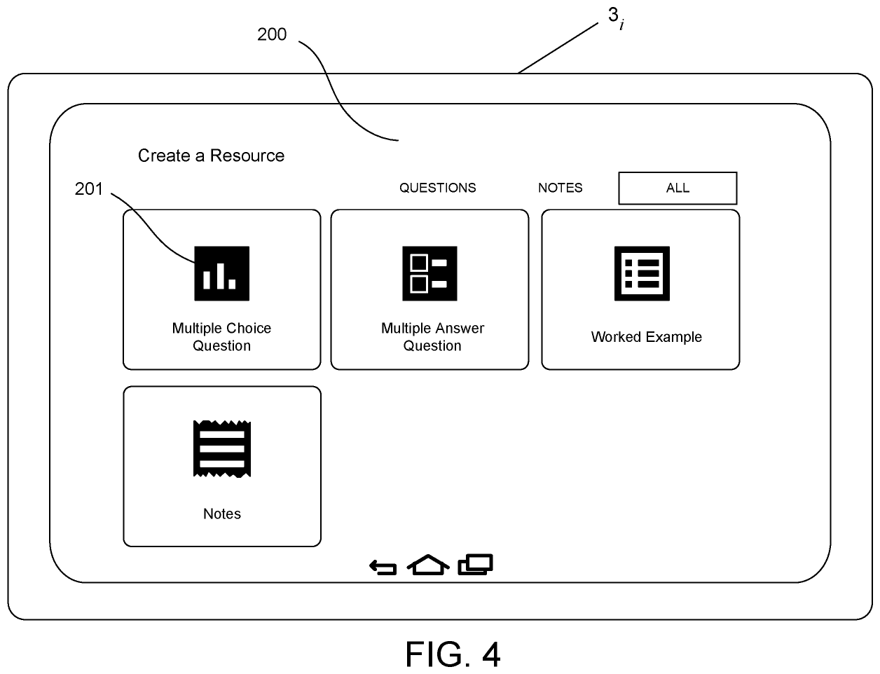

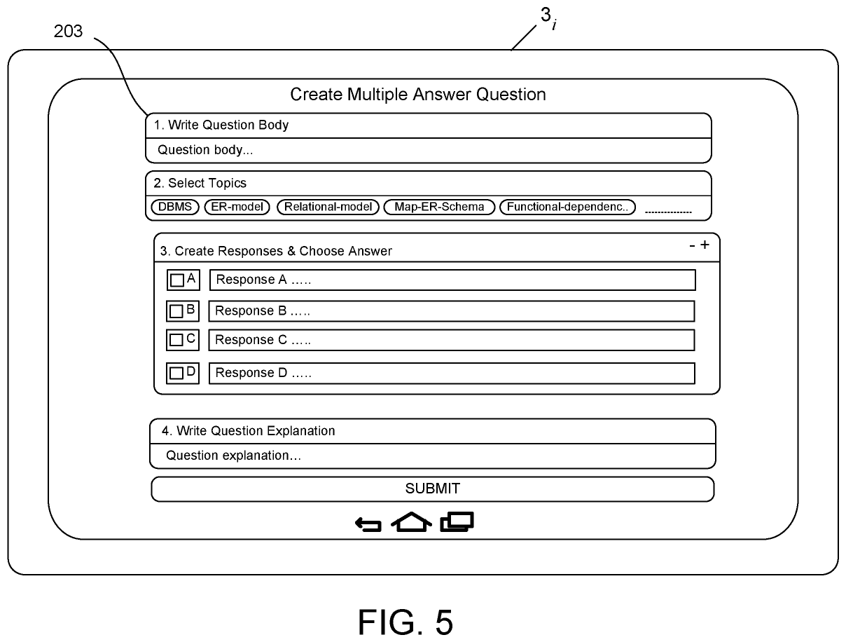

At box 100 rating generator assembly 30 receives a learning resource, e.g. learning resource qₖ via network 31. The learning resource qₖ may have been generated by one of the students (U_{N}={u₁, . . . ,u_{N}}) 3-1, . . . ,3-N or by one of Instructors 7-1, . . . ,7-L. FIG. 4 shows a student device 3ᵢ rendering a webpage 200 served by the rating generator assembly 30 for assisting a student uᵢ to create a learning resource. Webpage 200 provides buttons for the student to click on for assisting in the creation of a number of different types of learning resources. FIG. 5 shows the student device rendering a webpage 203 for creating multiple answer questions, subsequent to the student clicking on “Multiple Answer Question” button 201 in previous webpage 200.

At decision box 101, if rating generator assembly 30 determines (for example by meta-data associated with the learner resource, such as the sender's identity and position in the educational facility) that qₖ was sent by one of the students then at box 102 the rating generator assembly 30 stores the learning resource qₖ in the non-moderated resources area 72a of database 72. Alternatively, if at decision box 101 rating generator assembly 30 determines that qₖ was produced by one of the instructors 7-1, . . . ,7-L then at box 125 (FIG. 3B) rating generator assembly 30 stores the learning resource in the approved resources area 72c of database 72.

At decision box 103 the rating generator assembly 30 may take either of two paths. It may decide to proceed along a first path to box 105, where a student moderated procedure commences, or along a second path to box 127 where one or more of the Instructors 7-1, . . . ,7-L engage with the rating generator assembly to assist with ensuring that the learning resource quality ratings and student reliability ratings are being properly allocated. At box 103 the server checks the role of a user requesting to moderate, i.e. to provide one or more indications of quality, such as a decision rating and/or a comment in respect of a learning resource, to determine whether they are an instructor or a student.

At box 105, where the user requesting to moderate (i.e. available to moderate), is a student then the rating generator assembly 30 selects a non-moderated resource qⱼ from non-moderated resources area 72a of the database 72. The rating generator assembly 30 transmits the non-moderated resource qⱼ to one or more of the available students uᵢ via the data network 31 with a request for the students to evaluate the resource qⱼ. It is highly preferable that the rating generator assembly 30 is configured to provide the resource to the student without any identification of the author of the documents. This is so that the student moderation, i.e. allocation of a rating to the document by the student, is performed blindly, i.e. without there being any possibility of the student being influenced by prior knowledge of the author.

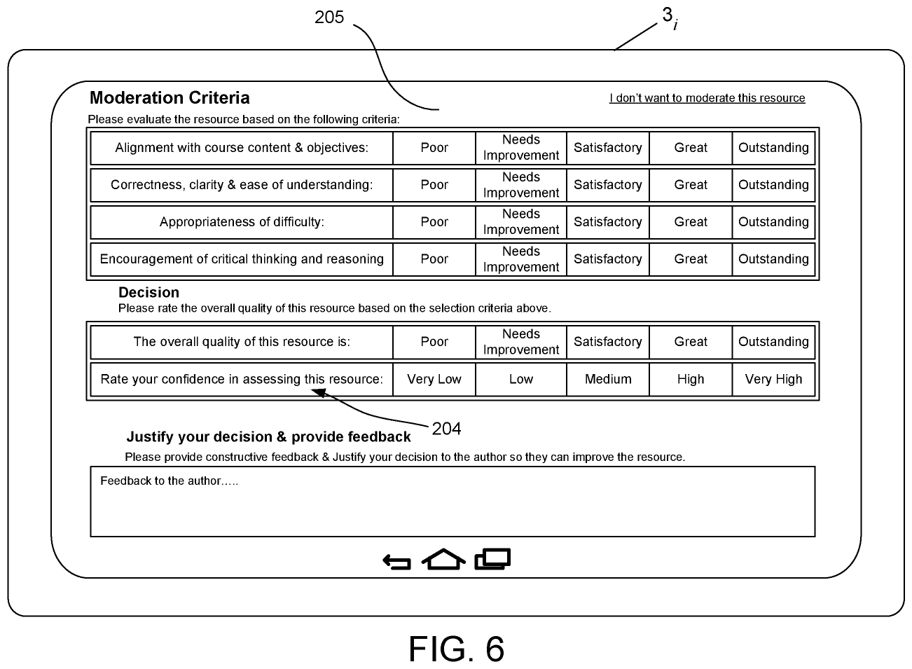

FIG. 6 shows student user device 3, rendering a webpage 205 for capturing the student's decision regarding the learning resource and a comment from the student. Subsequently the student uᵢ reviews the non-moderated resource qⱼ and transmits an indication of quality of the resource in the form of a decision rating dᵢⱼ and a comment cᵢⱼ back to the rating generator assembly 30. For example, in FIG. 1 student 3-3 (u₃) operates her device 3c (which in this case is a tablet or smartphone) to transmit a decision rating d_{3,208} (being a value on a scale of 1 to 5 in the present embodiment) in respect of learner resource q₂₀₈. Student 3-3 (u₃) also operates her device 3c to transmit a comment c_{3,208} being a text comment on the quality of the resource qⱼ in respect of an educational course that student 3-3 is familiar with. At box 107 the rating generator assembly 30 receives the decision rating dᵢⱼ and comment cᵢⱼ from student uᵢ in respect of the non-moderated resource qⱼ. As a further example, it will be observed in FIG. 1 that user 3-1 operates his device 3a, whilst rendering webpage 203 (FIG. 5) to similarly transmit a decision rating d_{1,312} and a comment c_{1,312} in respect of learning resource q₃₁₂.

At box 109 the rating generator assembly 30 computes a draft quality rating \hat{r}ⱼ in respect of the learning resource qⱼ based on the received decision rating d_{i,j} and comment c_{i,j} and an associated confidence value for the quality rating \hat{r}ⱼ .

At box 111, if the confidence value is below a threshold valuethreshold, then control diverts back to box 102 and the procedure through boxes 105 to box 109 repeats until a draft quality rating \hat{r}ⱼ is determined for a non-moderated learning resource qⱼ with a confidence value meeting a desirable required confidence level. In that case, at box 111 control proceeds to box 113 and the quality rating is set to the value of the final draft quality rating. An associated confidence value is also calculated. For example, if n moderators have reviewed a resource
u₁ has a reliability of w₁ and has a self-confidence rating of sc_{1.}
uᵢ has a reliability of wᵢ and has a self-confidence rating of sc_{i . . .}
uₙ has a reliability of wₙ and has a self-confidence rating of scₙ

The rating generator assembly 30 calculates the confidence value as an aggregated sum, i.e. confidence value=w₁*sc₁+w₂*sc₂ . . . wₙ*scₙ and compares that aggregated sum to a threshold value.

The confidence value increases as more non-expert moderators provide a quality rating for the digital resource being rated.

In terms of typical numbers, reliability values for non-expert moderators are 700<wᵢ<1300 and self-confidence ratings are 0<scᵢ<1. Two methods that may be used in relation to the confidence value and the threshold value are:
1. Instructors can set how many reviews “k” they expect on average for a resource (a default value of k=3 has been found to be workable). The threshold value is set taking into account the value of k. For example, threshold value=k*1000 (user with average reliability)*(0.8 user with high confidence in their rating)=2,400 as the threshold.

2. Instructors can set min and max number of moderations required for a resource (default values of min=3 and max=5 have been found to be workable.) k is then set to k=(min+max)/2 in the formula given in method 1. However, we also add an additional constraint on the lower and upper bounds values of the number of moderators when we make a decision. This second method has been found to provide a better estimate of how many moderations are needed to get n resources reviewed.

If the computed confidence value associated with the draft quality rating at box 109 exceeds the threshold, then control proceeds to box 113. Otherwise, control loops back to box 102 to obtain further moderations, i.e. by further non-expert moderators (students) in respect of the same digital resource until the associated confidence value at box 109 is exceeded. The self confidence values are directly input by the non-expert moderators into their devices 3, for example by means of data entry input field 204 of FIG. 6.

At box 113 the rating generator assembly 30 also updates the reliability ratings w₁, . . . ,wₙ of the students involved in arriving at the final quality rating \hat{r}ⱼ for the learning resource qⱼ. For example, at box 113 the rating generator assembly 30 may determine the reliability ratings wᵢ of the students uᵢ according to one or more of formulae (1) to (4) that have been previously discussed.

At box 115 the rating generator assembly 30 transmits the rating \hat{r}ⱼ that it has allocated to the resource qⱼ and any changes to the reliability ratings of the students involved, back to the devices 3a, . . . ,3N of the students, said students being an example of non-expert moderators. In a further step, subsequent to box 115 the moderators may be asked to take a look at the reviews from the other moderators and determine whether or not they agree with the decision that has been made. If they do not agree with the decision, disagreement is used to increase the priority of the resource being spot-checked by experts.

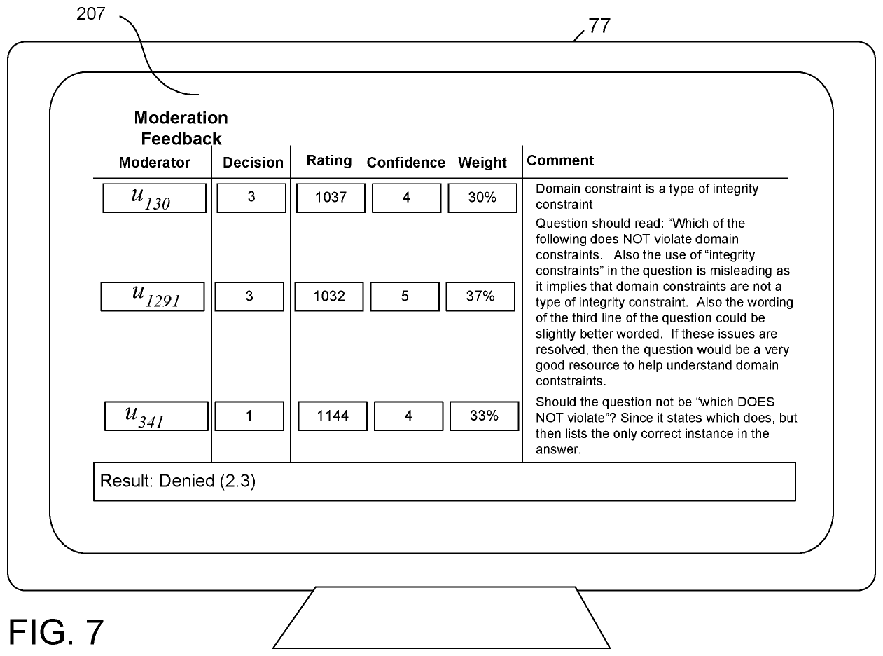

FIG. 7 depicts administrator device 77 displaying a webpage 207 served by rating generator assembly 30, which indicates to administrator 67 the feedback in respect of a particular learning resource. For example, moderator u₁₃₀ has provided a decision rating of “3”. The moderator has a reliability rating of 1037. The rating generator assembly has calculated a confidence value in the rating of “4” and a weight of “30%”.

Rating generator assembly 30 is preferably configured to implement an explainable rating system to simultaneously infer the reliability of student moderators and the quality of the resources. In one embodiment the method includes calculating values for the reliability and quality ratings in accordance with formulas 1) to 4) as previously discussed. The reliability of all of the student moderators may be initially set to an initial value of α. The quality of a resource as a weighted average of the decision ratings provided by student moderators and their ratings are then calculated. Preferably the calculation affords a greater weight to indications of quality from non-experts with a higher reliability indicator and a lower weight to indications of quality from non-experts with a lower reliability indicator.

Learning resources that are perceived as effective may be classified as such, for example by adding them to the repository of approved resources, e.g. area 72c of database 72. For example, a learning resource may be deemed to be “effective” taking into account alignment with the course content, correctness and clarity of the resource, appropriateness of the difficulty level for the course it is being used for and whether or not it promotes critical thinking The ratings of the student moderators may then be updated based on the “goodness” of their decision rating as previously discussed. Feedback about the moderation process may then be transmitted, via the data network, to the author of the learning resource and to the moderators.

At decision box 117, if the quality rating that was determined box 109 with above threshold confidence value was a quality rating that is below indicating the resource qⱼ to be an approved resource, then the rating generator assembly 30 proceeds to box 119 and moves the resource qⱼ from the non-moderated resources class 72a to the rejected resources class 72b in database 72. Subsequently, at box 121 the rating generator assembly 30 sends a message to the student that created the resource encouraging them to revise and resubmit the learning resource based on feedback that has been transmitted to them, e.g. the comments, that the resource received from students at box 107.

Alternatively, if at decision box 117 a decision is made to approve the learning resource qⱼ then control proceeds to box 123. At box 123 the rating generator assembly 30 sends the student that authored the resource a message encouraging the student to update the resource based on feedback, e.g. the comments that the resourced received from students at box 107. At box 125, rating generator assembly 30 then moves the resource qⱼ from the non-moderated resources class 72a to the approved resources class 72c of database 72.

At box 137 the rating generator assembly 30 determines the role of the user, e.g. “student” or “instructor”. For students the purpose of their engagement with approved resources may be to obtain an adaptive recommendation. For instructors it may be to check how they can best utilize their time with spot-checking.

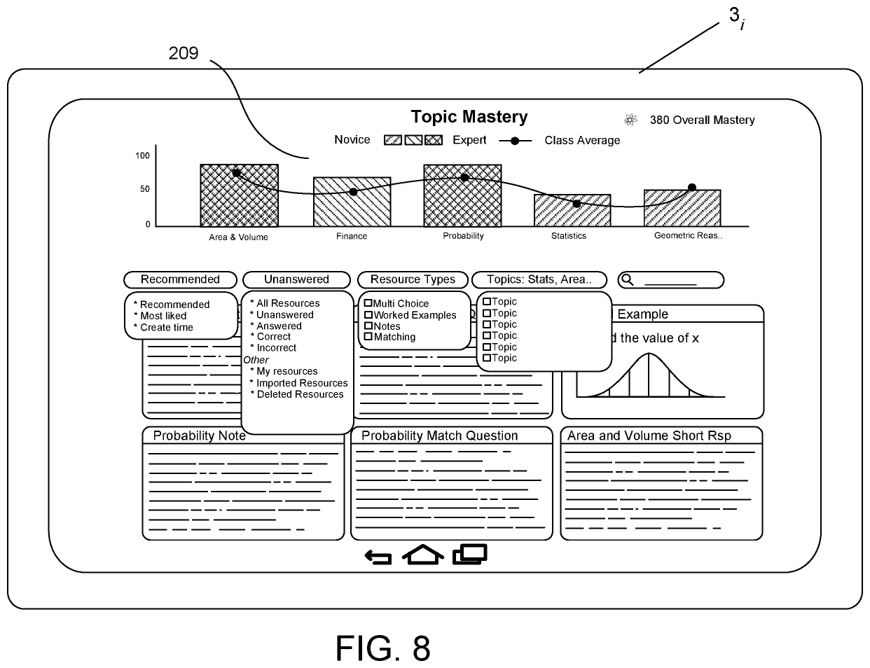

At box 139 the rating generator assembly 30 serves a webpage to students, e.g. webpage 209 on device 3ᵢ as shown in FIG. 8, recommending learning resources that are indicated as best suiting the students learning needs from the repository of approved learning resources 72c. The webpage includes a mastery level for the student that indicates the student's mastery of the syllabus of a particular course based on the students' responses whilst moderating the learning resources.

Returning to decision box 103, if at decision box 103 the rating generator assembly 30 finds that one of the instructors, e.g. instructor 7-i, of the instructors 7-1, . . . ,7-L is available, then at box 127 the rating generator assembly 30 identifies a “best” activity, such as a high priority activity, for the instructor 7-i to perform.

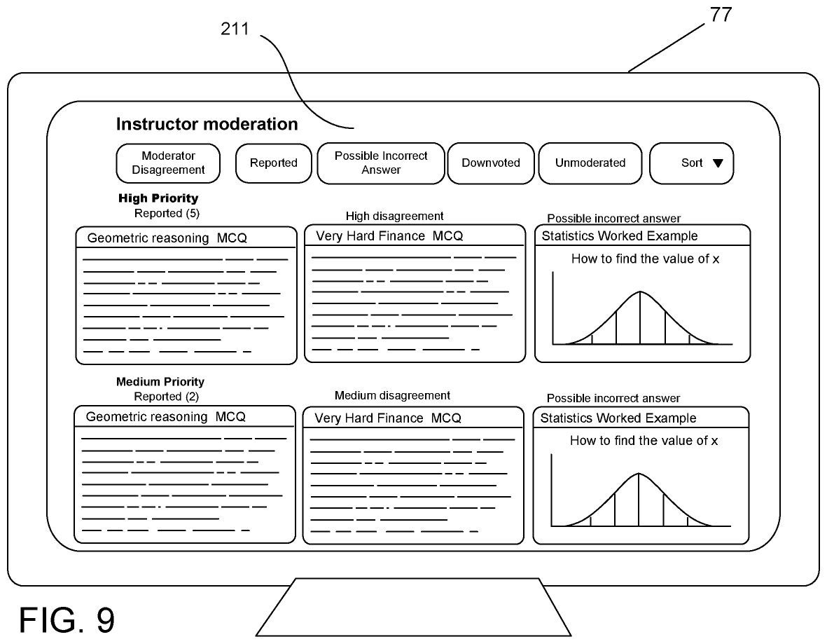

FIG. 9 depicts a webpage 211 rendered on administrator screen 77 that graphically illustrates high priority activities for instructor 7-i to perform.

At decision box 129, if the best activity that was identified at box 127 is to spot-check the learning resources q₁, . . . ,qₘ, for example to ensure that an approved resource should indeed have been approved, or a rejected resource should indeed have been rejected, then the procedure progresses to box 131. At box 131 the rating generator assembly 30 provides a resource qₛ to the instructor 7-i for the instructor to spot-check.

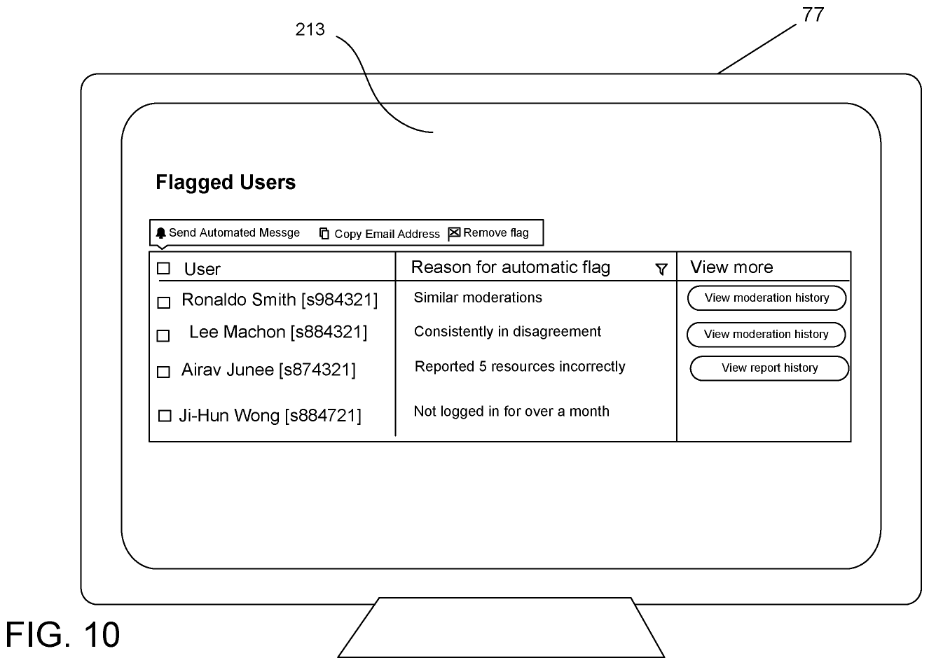

The instructor 7-i returns comment c_{i,r} and a decision rating dᵣ in respect of the resource qₛ which the rating generator assembly 30 then uses at boxes 113 and 115 to form an expert quality rating to update the quality rating of qₛ and to update the reliability rating of one or more of the students involved in authoring and/or prior quality rating of the resource qₛ. Based on the spot-checking at box 131, the rating generator assembly 30 may detect students that have made poor learning resource contributions or are misbehaving in the system. In that case, the rating generator assembly 30 serves a webpage that is rendered as screen 213 on the administrator device, i.e. display 77 as shown in FIG. 10 and which identifies problematic users and the associated reason for them having been flagged. For example, students may be flagged where they repetitively submit similar decision ratings and comments. Other reasons are that the student submits decision ratings and comments that are consistently in disagreement with a large number of other students' decision ratings and comments in respect of the same learning resource.

If at decision box 129, the best activity that was identified at box 127 is to check the quality of a learning resource contributed by a student uᵢ then at box 133 the rating generator assembly 30 provides a resource qₚ to an available instructor, e.g. instructor 7-L. The instructor 7-L then reviews the learning resource qₚ and sends a decision rating dₚ and comment c_{L,p} back to the rating generator assembly 30. The rating generator assembly 30 then updates the reliability rating wᵢ of student uᵢ based on the comment c_{L,p} and decision rating dₚ in respect of the learning resource qₚ that was created by student uᵢ and provides feedback to the student uᵢ advising of the new quality rating, reliability rating and of the instructor's comment. The feedback assists student uᵢ to 25 improve the initial quality of learning resources that will be generated by the student in the future.

At box 135 the rating generator assembly 30 updates the reliability of student u and transmits feedback to them based on the outcome of the review, if needed

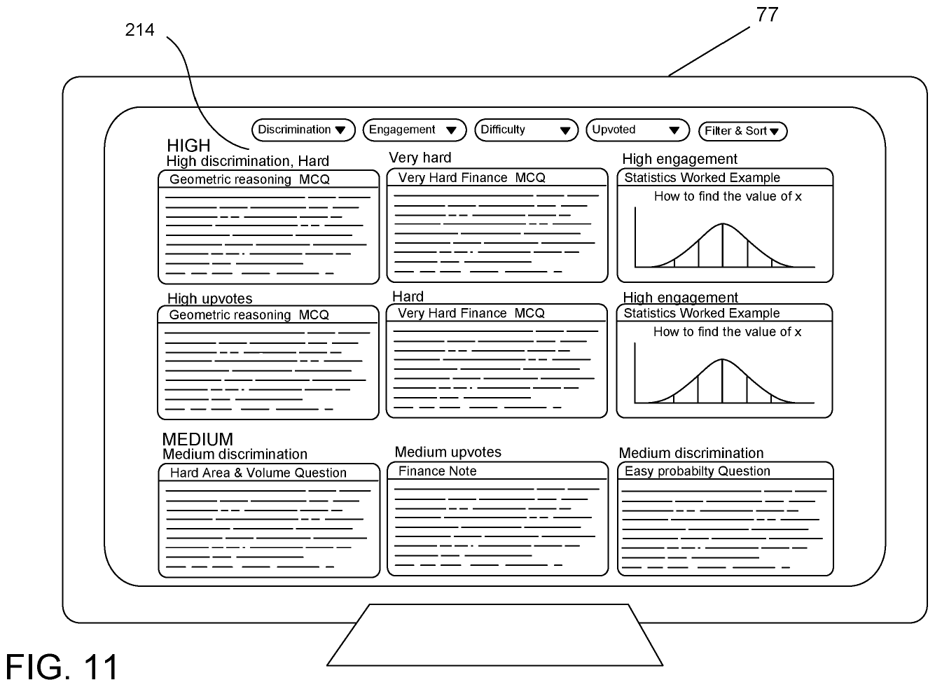

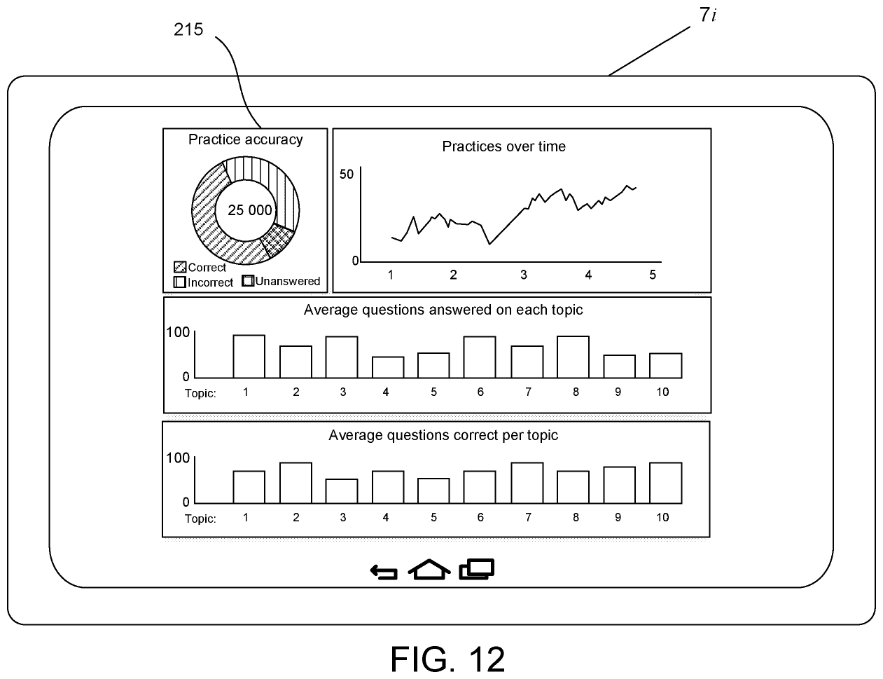

At any time the administrator 67 can request information from the rating generator assembly regarding quality rating and reliability ratings, for example as shown in screen 214 of administrator device 77 in FIG. 11. Instructors 7-1, . . . ,7-L can also view screens presenting analytics, dashboards and report in relation to the performance of the students, for example as shown in screen 215 (FIG. 12) on Instructor device 7i.

It will be realised that the exemplary embodiment that has been described is only one example of an implementation. For example, in other embodiments fewer features may be present, as previously discussed in relation to the first embodiment, or more features may be present. For example, embodiments of the method may assess quality and reliability of the moderators by configuring the rating generator assembly 30 to take into account factors including one or more of the following:
Moderator's competence which can be measured in a variety of ways
   Self-assessed confidence provided during the moderation (already in rubric)
   Course-level engagement and performance (e.g., number of questions answered, number of questions moderated, assignment grades achieved)
   Topic-level engagement and performance (e.g. number of questions answered/moderated on the topics that are associated with the resource)
   Other moderators of the same resource like or appraise the moderator for their provided comment and elaboration
Author's competence which can be measured in a variety of way similar to what was given above
Relatedness of the resource and the provided comment. For example, natural language processing models such as BERT may be used in this regard.
Effort—other than length of comment other metrics such as time-on-task may be used to measure effort

### References

The disclosures of each of the following documents are hereby incorporated herein by reference.
1. Abdi, S., Khosravi, H., Sadiq, S., Gasevic, D.: Complementing educational recommender systems with open learner models. In: Proceedings of the Tenth International Conference LAK. pp. 360-365 (2020)
2. Abdi, S., Khosravi, H., Sadiq, S., Gasevic, D.: A multivariate elo-based learner model for adaptive educational systems. In: Proceedings of the Educational Data Mining Conference. pp. 462-467 (2019)
3. Alenezi, H. S., Faisal, M. H.: Utilizing crowdsourcing and machine learning in education: Literature review. Education and Information Technologies pp. 1-16 (2020)
4. Aleven, V., McLaughlin, E. A., Glenn, R. A., Koedinger, K. R.: Instruction based on adaptive learning technologies. Handbook of research on learning and instruction pp. 522-560 (2016)
5. Boud, D., Soler, R.: Sustainable assessment revisited. Assessment & Evaluation in Higher Education 41(3), 400-413 (2016)
6. Bull, S., Ginon, B., Boscolo, C., Johnson, M.: Introduction of learning visualisations and metacognitive support in a persuadable open learner model. In: Proceedings of the 6th conference on learning analytics & knowledge. pp. 30-39 (2016)
7. Denny, P., Hamer, J., Luxton-Reilly, A., Purchase, H.: Peerwise: students sharing their multiple choice questions. In: Proceedings of the fourth international workshop on computing education research. pp. 51-58 (2008)
8. Doroudi, S., Williams, J., Kim, J., Patikorn, T., Ostrow, K., Selent, D., Heffernan, N. T., Hills, T., Ros'e, C.: Crowdsourcing and education: Towards a theory and praxis of learnersourcing. International Society of the Learning Sciences (2018)
9. Guerra, J., Hosseini, R., Somyurek, S., Brusilovsky, P.: An intelligent interface for learning content: Combining an open learner model and social comparison to support self-regulated learning and engagement. In: Proceedings of the 21st International Conference on Intelligent User Interfaces. p. 152-163 (2016)
10. Heffernan, N. T., Ostrow, K. S., Kelly, K., Selent, D., Van Inwegen, E. G., Xiong, X., Williams, J. J.: The future of adaptive learning: Does the crowd hold the key? International Journal of Artificial Intelligence in Education 26(2), 615-644 (2016) 11. Karataev, E., Zadorozhny, V.: Adaptive social learning based on crowdsourcing. IEEE Transactions on Learning Technologies 10(2), 128-139 (2016)
12. Khosravi, H., Cooper, K.: Topic dependency models: Graph-based visual analytics for communicating assessment data. Journal of Learning Analytics 5(3), 136-153 (2018)
13. Khosravi, H., Gyamfi, G., Hanna, B. E., Lodge, J.: Fostering and supporting empirical research on evaluative judgement via a crowdsourced adaptive learning system. In: Proceedings of the Tenth International Conference on Learning Analytics & Knowledge. pp. 83-88 (2020)
14. Khosravi, H., Kitto, K., Joseph, W.: Ripple: A crowdsourced adaptive platform for recommendation of learning activities. Journal of Learning Analytics 6(3), 91-105 (2019)
15. Kim, J., Nguyen, P. T., Weir, S., Guo, P. J., Miller, R. C., Gajos, K. Z.: Crowdsourcing step-by-step information extraction to enhance existing how-to videos. In: Proceedings of the SIGCHI Conference on Human Factors in Computing Systems. pp. 4017-4026 (2014)
16. Kim, J., et al.: Learnersourcing: improving learning with collective learner activity. Ph.D. thesis, Massachusetts Institute of Technology (2015)
17. Krishnan, S., Patel, J., Franklin, M. J., Goldberg, K.: A methodology for learning, analyzing, and mitigating social influence bias in recommender systems. In: Proceedings of the 8th Conference on Recommender systems. pp. 137-144 (2014)
18. Naldi, M.: A review of sentiment computation methods with r packages. arXiv preprint arXiv: 1901.08319 (2019)
19. Par'e, D. E., Joordens, S.: Peering into large lectures: examining peer and expert mark agreement using peerscholar, an online peer assessment tool. Journal of Computer Assisted Learning 24(6), 526-540 (2008)
20. Purchase, H., Hamer, J.: Peer-review in practice: eight years of aropä. Assessment & Evaluation in Higher Education 43(7), 1146-1165 (2018)
21. Rinker, T.: Sentimentr: Calculate text polarity sentiment. version 2.4.0 (2018)
22. Shnayder, V., Parkes, D. C.: Practical peer prediction for peer assessment. In: Fourth AAAI Conference on Human Computation and Crowdsourcing (2016)
23. Venanzi, M., Guiver, J., Kazai, G., Kohli, P., Shokouhi, M.: Community-based bayesian aggregation models for crowdsourcing. In: Proceedings of the 23rd international conference on World wide web. pp. 155-164 (2014)
24. Wang, W., An, B., Jiang, Y.: Optimal spot-checking for improving evaluation accuracy of peer grading systems. In: Thirty-Second AAAI Conference on Artificial Intelligence (2018)
25. Wang, X., Talluri, S. T., Rose, C., Koedinger, K.: Upgrade: Sourcing student open ended solutions to create scalable learning opportunities. In: Proceedings of the Sixth (2019) ACM Conference on Learning Scale. pp. 1-10 (2019)
26. Williams, J. J., Kim, J., Rafferty, A., Maldonado, S., Gajos, K. Z., Lasecki, W. S.,Heffernan, N.: Axis: Generating explanations at scale with learnersourcing and machine learning. In: Proceedings of the Third (2016) ACM Conference on Learning@ Scale. pp. 379-388 (2016)
27. Willis, A., Davis, G., Ruan, S., Manoharan, L., Landay, J., Brunskill, E.: Keyphrase extraction for generating educational question-answer pairs. In: Proceedings of the Sixth (2019) ACM Conference on Learning@ Scale. pp. 1-10 (2019)
28. Wind, D. K., Jorgensen, R. M., Hansen, S. L.: Peer feedback with peergrade. In:

ICEL 2018 13th International Conference on e-Learning. p. 184. Academic Conferences and publishing limited (2018)
29. Wright, J. R., Thornton, C., Leyton-Brown, K.: Mechanical ta: Partially automated high-stakes peer grading. In: Proceedings of the 46th ACM Technical Symposium on Computer Science Education. pp. 96-101 (2015)
30. Zheng, Y., Li, G., Li, Y., Shan, C., Cheng, R.: Truth inference in crowdsourcing: Is the problem solved? Proceedings of the VLDB Endowment 10(5), 541-552 (2017)

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described herein comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the scope of the invention.
1-29. (canceled)

30. A method to associate quality ratings with each digital resource of a plurality of digital resources, the method comprising, in respect of each of the digital resources:
(a) receiving one or more indications of quality of the digital resource from respective devices (“non-expert devices”) of a plurality of non-experts via a data network;
(b) operating at least one processor to process the one or more indications of quality from each of said respective non-expert devices to determine a draft quality rating and a level of confidence therefor;
(c) repeating (a) in respect of indications of quality from further of the non-expert devices and (b) to update the draft quality rating until the level of confidence meets a required confidence level; and
(d) setting the quality rating to the draft quality rating having an associated level of confidence meeting the required confidence level.

31. The method of claim 30, including operating the at least one processor to classify the digital resource as an approved resource based upon the quality rating or as a rejected resource based upon the quality rating.

32. The method of claim 31, including operating the at least one processor to transmit a message to a device of an author of the rejected resource, the message including the quality rating and one or more of the one or more indications of quality received at (a), wherein the one or more indications of quality include decision ratings (dᵢⱼ) provided by the non-experts (uᵢ) in respect of the digital resource (qᵢ)

33. The method of claim 32, wherein the one or more indications of quality include comments (cᵢⱼ) provided by the non-experts (uᵢ) in respect of the digital resource (qᵢ) and wherein the method includes operating the at least one processor to process the comments in respect of the digital resource to quantify the comments as indicating a degree of positive or negative sentiment toward the digital resource.

34. The method of claim 33, wherein operating the at least one processor to process the comments to quantify the comments as indicating a degree of positive or negative sentiment toward the digital resource includes operating the at least one processor to apply a sentiment lexicon to the comments to compute sentiment scores; and
operating the at least one processor to calculate a reliability indicator in respect of each non-expert indicating reliability of the indications of quality provided by the non-expert.

35. The method of claim 34, wherein in (b),
operating at least one processor to process the one or more indications of quality from each of said respective non-expert devices to determine the draft quality rating and the level of confidence therefor includes:
affording a greater weight to indications of quality from non-experts with a higher reliability indicator and a lower weight to indications of quality from non-experts with a lower reliability indicator when determining the draft quality rating and the level of confidence therefor.

36. The method of claim 34, including operating the at least one processor to transmit the reliability indicators across the data network to respective non-expert devices of the non-experts for viewing by the non-experts.

37. The method of claim 34, wherein calculating a reliability indicator in respect of each non-expert comprises:
setting reliability indicators of all students to an initial value;
computing a quality rating for a resource based on current values of the reliability indicators of a number of the non-experts;
updating the reliability indicators according to a heuristic procedure.

38. The method of claim 37, wherein the heuristic procedure comprises:
calculating:
$${\hat{r}}_{j} = \frac{{\sum }_{i = 1}^{k} {w}_{i} \times {d}_{ij}}{{\sum }_{i = 1}^{k} {w}_{i}} , {w}_{i} := {w}_{i} + {f}_{ij}^{R} \qquad ( 1 )$$
where fᵢⱼ^{R} is computed as a height of a Gaussian function at value difᵢⱼ with centre 0 using
$${f}_{ij}^{R} = δ \times \frac{{e}^{- {( {d}_{i} {f}_{ij} )}^{2} / ( 2 {σ}^{2} )}}{σ \sqrt{2 π}} - \frac{δ}{2}$$
where hyper-parameters σ and δ are learned via cross-validation; or calculating:
$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{L} \qquad ( 2 )$$
where F_{N×M}^{L} is a function in which fᵢⱼ^{L} is computed based on a logistic function
$$\frac{c}{1 + {ae}^{- k \times {lc}_{ij}}}$$
where the hyper-parameters c, a and k of the logistic function are learned via cross-validation; or. calculating:
$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{A} \qquad ( 3 )$$
where fᵢⱼ^{A} approximates alignment of the rating dᵢⱼ and the comment cᵢⱼ a user uᵢ has provided for a resources qⱼ.

39. The method of claim 37, wherein the heuristic procedure includes determining the reliability indicators using a combination of two or more of each of three heuristic procedures as follows:
calculating:
$${\hat{r}}_{j} = \frac{{\sum }_{i = 1}^{k} {w}_{i} \times {d}_{ij}}{{\sum }_{i = 1}^{k} {w}_{i}} , {w}_{i} := {w}_{i} + {f}_{ij}^{R} \qquad ( 1 )$$
where fᵢⱼ^{R} is computed as a height of a Gaussian function at value difᵢⱼ with centre 0 using
$${f}_{ij}^{R} = δ \times \frac{{e}^{- {( {d}_{i} {f}_{ij} )}^{2} / ( 2 {σ}^{2} )}}{σ \sqrt{2 π}} - \frac{δ}{2}$$
where hyper-parameters σ and δ are learned via cross-validation; and/or calculating:
$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{L} \qquad ( 2 )$$
where F_{N×M}^{L} is a function in which fᵢⱼ^{L} is computed based on a logistic function
$$\frac{c}{1 + {ae}^{- k \times {lc}_{ij}}}$$
where the hyper-parameters c, a and k of the logistic function are learned via cross-validation; and/or calculating:
$${\hat{r}}_{j} = \frac{{\sum }_{i = 1}^{k} ( {w}_{i} \times {f}_{ij}^{L} ) \times {d}_{ij}}{{\sum }_{i = 1}^{k} ( {w}_{i} + {f}_{ij}^{L} )} , {w}_{i} := {w}_{i} + {f}_{ij}^{A} \qquad ( 3 )$$
where fᵢⱼ^{A} approximates alignment of the rating dᵢⱼ and the comment cᵢⱼ a user uᵢ has provided for a resources qⱼ.

40. The method of claim 30, including establishing data communications with respective devices (“expert devices”) of a number of experts via the data network.

41. The method of claim 40, including requesting an expert of the number of experts to review a digital resource and receiving a quality rating (“an expert quality rating”) from the expert via an expert device of the expert in respect of the digital resource.

42. The method of claim 41, including operating the at least one processor to set a quality rating in respect of the digital resource to the expert quality rating, transmitting feedback on the digital resource received from the expert across the data network, to an author of the digital resource and transmitting a request to the expert device for the expert to check indications of quality received from the non-expert devices for respective digital resources.

43. A system for associating quality ratings with each digital resource of a plurality of digital resources, the system comprising:
a plurality of non-expert devices of respective non-experts;
a rating generator assembly;
a data network placing the plurality of non-expert devices in data communication with the rating generator assembly;
one or more data sources accessible to or integrated with the rating generator assembly for storing the digital resources;
wherein the rating generator assembly is configured to:
(a) receive one or more indications of quality from the non-expert devices via the data network;
(b) process the one or more indications of quality from each of said respective non-expert devices to determine a draft quality rating and level of confidence therefor;
(c) repeat step (a) for indications of quality from further of the non-expert devices and step (b) to thereby update the draft quality rating until the level of confidence meets a required confidence level; and
(d) set the quality rating to the draft quality rating having an associated level of confidence meeting the required confidence level.

44. A rating generator assembly for associating quality ratings with each digital resource of a plurality of digital resources the rating generator assembly comprising:
a communications port for establishing data communications with a plurality of respective devices (“non-expert devices”) of a plurality of non-experts via a data network;
at least one processor responsive to the communications port;
at least one data source storing the plurality of digital resources and in data communication with the at least one processor;
an electronic memory bearing machine-readable instructions for execution by the at least one processor, the machine-readable instructions including instructions for the at least one processor to perform, for each of the digital resources;
(a) receiving one or more indications of quality of the digital resource from the non-expert devices via a data network;
(b) processing the one or more indications of quality from each of said respective non-expert devices to determine a draft quality rating and level of confidence therefor;
(c) repeating (a) for indications of quality from further of the non-expert devices and (b) to update the draft quality rating until the level of confidence meets a required confidence level; and
(d) setting the quality rating to the draft quality rating having an associated level of confidence meeting the required confidence level.
